(19) United States
(12) Patent Application Publication
(10) Pub. No.: US 2026/0311985 A1
(43) Pub. Date: Oct. 8, 2026

(54) Ion Gate

(71) Applicant: Thermo Fisher Scientific (Bremen) GmbH, Bremen (DE)

(72) Inventors: Ralf Günter Hartmer, Hamburg (DE); Dmitry Grinfeld, Bremen (DE); Frederik Busse-Patel, Bremen (DE); Hamish Stewart, Bremen (DE)

(21) Appl. No.: 19/481,599

(22) PCT Filed: May 10, 2024
(86) PCT No.: PCT/EP2024/062960

§ 371 Date: Nov. 5, 2025

(30) Foreign Application Priority Data
May 12, 2023 (GB) GB2307092.3

(51) Int. Cl. H01J 49/06

(52) U.S. Cl. CPC H01J 49/061

(57) ABSTRACT

An ion gate is provided for a mass spectrometer. A first electrode assembly comprises a plurality of guide electrodes arranged to define a multipole ion guide from a first end to a second end of the first electrode assembly. The ion guide is configured to receive an ion beam at the first end. The guide electrodes are configured to receive RF voltages to define a confinement volume for the ion beam. A second electrode assembly comprises at least one gating electrode that intersects a guide electrode, wherein the at least one gating electrode is positioned adjacent to the first electrode assembly, outside of the confinement volume; and between the first end and the second end of the first electrode assembly. The at least one gating electrode is configured to receive a DC voltage that is changeable between a passing DC voltage and a gating DC voltage.

### RELATED REFERENCE

This application is the U.S. National Stage, under 35 U.S.C. § 371, of International application PCT/EP2024/062960, having an international fling date of May 10, 2024, which claims priority to Great Britian application no. GB2307092.3 filed on May 12, 2023, which is incorporated by reference in its entirety.

### FIELD OF THE DISCLOSURE

This invention relates to an ion gate, in particular for use in a mass spectrometer. The invention also relates to a method of controlling the transmission of an ion beam through such an ion gate.

### BACKGROUND

Mass spectrometers typically transfer ions from an ion source to an ion trap, either for analysis in the ion trap or to be passed on to a downstream analyser. For mass spectrometers with a continuous or quasi-continuous ion source, well-defined portions of the ion beam should be sampled to provide quantitative and reproducible analysis. To enable this, an ion gate is used to control the population of ions passing into the ion trap.

Typically, known ion gate designs employ lens apertures that are used to defocus or deflect the ion beam.

Several known methods of preventing ion transmission are described in US5750993. The ions may pass through a tube lens configured to provide an electrostatic field, followed by a skimmer. The voltage of the tube lens is adjusted to allow ions to pass through the skimmer, or to prevent ions from passing through the skimmer. For positive ions, a negative direct current (DC) voltage applied to the tube lens defocusses the ion beam to prevent the ions from entering the skimmer. A positive DC voltage applied to the tube lens allows ions to pass through the skimmer into the ion trap. US5750993 also describes blocking ions by applying a repelling DC potential difference between two successive ion guides or between an ion guide and a lens, by applying a high DC voltage to the second ion guide or lens. Although this blocks the passage of charged particles, the ion time of flight through the blocking region is relatively long and so it is a relatively slow gating method. Furthermore, a potential well may be formed within the first ion guide, trapping and storing ions and so adversely affecting quantitation. US5750993 also suggests applying a low radio frequency (RF) voltage to an ion guide to inhibit transmission of the ions. As for the DC method, the flight time of ions through the blocking region is relatively long and so the gating method is relatively slow.

A split lens may be used as an ion gate, as described in US20030141449. The ions are deflected laterally away from the device axis and are blocked by an exit aperture. When the two parts of the split lens are at the same, low, voltage the ions are transmitted along the device axis. When the two parts of the split lens have higher voltages of opposite polarities, the ion beam is deflected. A split lens may also be used for focussing the ion beam. Another example of a split lens is described in US7183542. A split lens is used in the ThermoFisher Orbitrap Exploris platform.

These ion gates use a lens to defocus or deflect the ion beam. The apertures may limit the ion beam radius, limiting transmission. The apertures may also be prone to contamination and charge buildup after prolonged periods of use.

A Bradbury-Nielsen ion gate, as described in US7176452, uses a grid of wires rather than a lens. The grid of wires is in a plane orthogonal to the ion path, and alternating electric potentials are applied to adjacent wires to defocus an ion beam passing through the grid. The ions pass close to the electrodes, making gating times fast. This is beneficial for applications where ions are gated based on their flight time. However, since the electrodes are directly in the path of the ions, they suffer from contamination from impinging ions.

Also in the field of mass spectrometers, it is known that auxiliary DC electrodes near to the radius of a multipole channel may be used to axially trap or direct ions. This is known to have a side effect of locally perturbing the trapping RF pseudopotential and removing weakly trapped species. This side-effect has previously been described as a disadvantage, since it limits the trapping m/z range and ion capacity. (Stewart, H., Hock, C., Giannakopulos, A., Grinfeld, D., Heming, R. and Makarov, A., A rectilinear pulsed-extraction ion trap with auxiliary axial DC trapping electrodes, Proceedings of the 66th ASMS Conference on Mass Spectrometry and Allied Topics, San Antonio, TX, 2018).

### SUMMARY OF THE DISCLOSURE

Against this background, according to a first aspect of the disclosure there is provided an ion gate for a mass spectrometer according to claim 1. The ion gate comprises a first electrode assembly comprising a plurality of guide electrodes aligned along a central axis. The plurality of guide electrodes are arranged to define a multipole ion guide from a first end of the first electrode assembly to a second end of the first electrode assembly wherein at least one guide electrode is continuous from the first end of the first electrode assembly to the second end of the first electrode assembly. The ion guide is configured to receive an ion beam at the first end. The plurality of guide electrodes are configured to receive RF voltages to define a confinement volume for the ion beam, wherein the confinement volume is centred about the central axis. The ion gate further comprises a second electrode assembly comprising at least one gating electrode that intersects a guide electrode, wherein the at least one gating electrode is positioned adjacent to the first electrode assembly; outside of the confinement volume; and between the first end of the first electrode assembly and the second end of the first electrode assembly, wherein the at least one gating electrode is configured to receive a DC voltage that is changeable between a passing DC voltage such that the ion beam is transmitted along the ion guide; and a gating DC voltage such that the ion beam is prevented from transmission along the ion guide.

In this way, the ion gate may be used to control the population of ions passing along the ion guide, for example to be passed into an ion trap. When the ions are analysed downstream of the ion gate, the observed ion signal may be quantified based on the length of time for which the at least one gating electrode receives a passing DC voltage. Controlling the population of ions transmitted to an ion trap or a subsequent analyser may also be used to stay below the space charge capacity of the ion trap or analyser. Controlling the population of ions transmitted to an ion trap or a subsequent analyser may also be used to reduce contamination of subsequent ion optics, particularly when the duty cycle of the analysis is low. As the ion gate is integrated into an ion guide, the ion beam does not diverge in the gating region. Therefore, no re-focusing optics are required, such as apertures that may radially confine the ion beam and may be prone to contamination and charge-up. An aperture may also restrict pumping, which is avoided with the ion gate of the present invention. In scenarios where such a restriction is desired, e.g. in between pressure stages, the inner cross section of the ion gating multipole can be seen as the restriction, and the desired gas conductance can be achieved by elongating the device.

The at least one gating electrode may intersect a guide electrode such that the guide electrode is continuous.

The at least one gating electrode intersects a guide electrode such that the guide electrode is continuous in a direction parallel to the central axis. The guide electrodes are, therefore, each continuous between the first end and the second end, without requiring any break or discontinuity to accommodate the one or more gating electrode. Advantageously, when the at least one gating electrode receives a passing DC voltage, the electric potential of the ion guide is not significantly impacted by the gating electrodes. The ion gate of this disclosure does not require acceleration of ions, as may be required to preserve ion transmission across apertures or between consecutive ion guides. The ion gate of this disclosure therefore avoids any time delay associated with accelerating the ions (since acceleration of the ions may need to be thermalised) as well as any unintended ion activation resulting from the acceleration. In use, the ion gate of this disclosure has a DC voltage applied to the one or more gating electrode and has RF voltages applied to the guide electrodes, such that gating of ions is provided by a DC voltage.

Integrating the gating electrode into the guide electrodes in this way allows the ion gate to be integrated into an ion guide such that the ion guide is continuous.

Advantageously, the ion beam does not diverge in the gating region, as it might for an ion gate that is separate from an ion guide.

More than one guide electrode may be continuous from the first end of the first electrode assembly to the second end of the first electrode assembly. Preferably, most of the guide electrodes may be continuous from the first end of the first electrode assembly to the second end of the first electrode assembly, wherein most of the guide electrodes may comprise all but one of the guide electrodes, or 75% or above of the guide electrodes. More preferably, all of the guide electrodes may be continuous from the first end of the first electrode assembly to the second end of the first electrode assembly.

A radial distance of the at least one gating electrode from the central axis may be no less than half a radial distance of the first electrode assembly from the central axis.

In this way, the gating electrode may be outside of the confinement volume (and, therefore, outside of the path of the ion beam). This may reduce disturbance of the potential well inside the confinement volume by the at least one gating electrode when the at least one gating electrode receives a passing DC voltage. Furthermore, contamination of the gating electrode may be reduced.

The at least one gating electrode may be positioned outside of a central volume, wherein the central volume extends from the central axis to a surface of each of the plurality of guide electrodes that is closest to the central axis.

In this way, the at least one gating electrode is outside of the confinement volume defined by the RF voltages. This may reduce disturbance of the potential well inside the confinement volume by the at least one gating electrode when the at least one gating electrode receives a passing DC voltage. In other words, when the at least one gating electrode receives a passing DC voltage, the potential well inside the confinement volume may be similar to or substantially the same as the potential well that would be achieved by the plurality of guide electrodes in the absence of any gating electrode. Furthermore, contamination of the one or more gating electrode may be reduced by this arrangement.

The at least one gating electrode may be positioned at a first axial distance from the first end of the first electrode assembly and at a second axial distance from the second end of the first electrode assembly.

The first guide electrode may be shaped such that the first guide electrode does not fully shield the electric field of the gating electrode.

Advantageously, the electric field of the gating electrode may not be prevented by the guide electrode from penetrating towards the central axis of the confinement volume.

The first guide electrode may comprise a slot configured to accommodate the gating electrode.

Advantageously, the slot may allow the gating electrode to be integrated into an ion guide. The slot may be shaped such that the first guide electrode does not fully shield the gating electrode.

The plurality of ion guide electrodes may comprise a first guide electrode and a second guide electrode, wherein the first guide electrode opposes the second guide electrode. The plurality of ion guide electrodes may further comprise a primary guide electrode assembly and a secondary guide electrode assembly, wherein the primary guide electrode assembly opposes the secondary guide electrode assembly. The primary guide electrode assembly comprises a first sheet electrode and a second sheet electrode, and the secondary guide electrode assembly comprises a third sheet electrode and a fourth sheet electrode.

Advantageously, a gap between the first sheet electrode and the second sheet electrode (and/or a gap between the third sheet electrode and the fourth sheet electrode) may allow the electric field of the gating electrode to penetrate the confinement volume towards or as far as the central axis. The gating electrode may not be fully shielded by the guide electrodes.

The gating electrode may intersect the first sheet electrode and the second sheet electrode.

Advantageously, a gap between the first sheet electrode and the second sheet electrode (and/or a gap between the third sheet electrode and the fourth sheet electrode) may allow the electric field of the gating electrode to penetrate the confinement volume towards or as far as the central axis. The gating electrode may not be fully shielded by the guide electrodes.

The ion guide may further comprise one or more additional DC bias electrodes configured to provide an axial DC field, wherein the one or more DC bias electrodes are adjacent to the first electrode assembly and wherein the gating electrode intersects the one or more DC bias electrodes.

The gating electrode may be symmetrical along a linear axis.

Advantageously, the gating electrode may be removable from the guide electrodes, allowing for cleaning.

The gating electrode may have cylindrical symmetry.

Advantageously, the gating electrode may be rotatable such that a contaminated surface of the gating electrode may be moved away from the confinement volume, prolonging the length of time for which a gating electrode may be used before it requires cleaning.

The linear axis of the gating electrode may be perpendicular to the central axis.

In this way, the electric field of the gating electrode may be perpendicular to the direction of travel of the ion beam, so may deflect the ion beam laterally.

The gating DC voltage may be configured to attract the ion beam such that the ion beam is deflected towards a gating electrode.

Advantageously, an attractive potential may be more efficient for deflecting an ion beam.

The second electrode assembly may comprise a first gating electrode and a second gating electrode.

Advantageously, using two gating electrodes may provide more efficient deflection of the ion beam. For example, using two gating electrodes with opposite polarities of the deflecting voltages may reduce the required DC amplitudes for fully deflecting ions, and may also yield a more symmetrical potential distribution in passing mode.

In a passing mode the passing DC voltage with respect to an ion guide offset may be applied to the first and second gating electrodes and in a gating mode the gating DC voltage may be applied to the first gating electrode and the passing DC voltage is applied to the second gating electrode.

In this way, the ion beam may be deflected by the first gating electrode.

In a passing mode the passing DC voltage with respect to an ion guide offset may be applied to the first gating electrode with and to the second gating electrode with the same polarity, and wherein in a gating mode the gating DC voltage is applied to the first gating electrode with a first polarity and the gating DC voltage is applied to the second gating electrode with a second polarity opposite to the first polarity.

Advantageously, using two gating electrodes with voltages of opposite polarities with respect to an ion guide DC offset may reduce the required amplitude of the gating DC voltage for fully deflecting the ion beam. Additionally, using two gating electrodes may achieve a more symmetrical potential distribution in the passing mode.

In an event that the gating electrode receives a gating DC voltage, the ion beam may be deflected laterally away from the central axis and out of the confinement volume.

In this way, the ions may be removed from the ion gate in the gating mode. The ions are not stored in the ion gate so are not released when the ion gate is changed to be in the passing mode. Releasing stored ions may distort quantitative measurements, since more ions may be transmitted than is expected from the length of time that the ion gate is in passing mode.

In an event that the gating electrode receives a gating DC voltage, the ion beam may be stored within the confinement volume.

In this way, the ions may be released when the ion gate is changed to be in the passing mode.

According to a second aspect of the disclosure there is also provided an ion guide according to claim 22, the ion guide comprising the ion gate of the first aspect of the disclosure.

In this way the ion gate may be used to prevent or allow transmission of ions along the ion guide, without divergence of the ion beam or the need for additional ion optics.

According to a third aspect of the disclosure, there is also provided a mass spectrometer according to claim 23, the mass spectrometer comprising an ion guide comprising a first ion gate of the first aspect of the disclosure.

The mass spectrometer may further comprise a second ion gate.

The second ion gate maybe positioned upstream of the first ion gate such that an ion beam reaches the second ion gate before the first ion gate and wherein a response time of the second ion gate is slower than a response time of the first ion gate.

The second ion gate may be positioned downstream of the first ion gate such that an ion beam reaches the second ion gate after the first ion gate and wherein a response time of the second ion gate is faster than a response time of the first ion gate.

Advantageously, contamination may be reduced for the downstream ion gate having the faster reaction time.

According to a fourth aspect of the disclosure, a method is provided of controlling transmission of an ion beam through an ion gate in a mass spectrometer according to claim 24. The ion gate comprises a first electrode assembly comprising a plurality of guide electrodes aligned along a central axis. The plurality of guide electrodes are arranged to define a multipole ion guide from a first end of the first electrode assembly to a second end of the first electrode assembly wherein at least one guide electrode is continuous from the first end of the first electrode assembly to the second end of the first electrode assembly. The ion guide is configured to receive an ion beam at the first end. The ion gate further comprises a second electrode assembly comprising at least one gating electrode that intersects a guide electrode, wherein the at least one gating electrode is axially positioned adjacent to the first electrode assembly; outside of the confinement volume; and between the first end of the first electrode assembly and the second end of the first electrode assembly and radially positioned outside of the confinement volume. The method comprises applying RF voltages to the plurality of guide electrodes to define a confinement volume for the ion beam, wherein the confinement volume is centred about the central axis. The method further comprises allowing transmission of the ion beam by applying a passing DC voltage to the gating electrode such that the ion beam is transmitted along the ion guide. The method further comprises preventing transmission of the ion beam by applying a gating DC voltage to the gating electrode such that the ion beam is prevented from transmission along the ion guide.

Applying the gating DC voltage to the gating electrode may attract the ion beam such that the ion beam is deflected towards a gating electrode.

The second electrode assembly may comprise a first gating electrode and a second gating electrode, wherein:
in a passing mode the passing DC voltage with respect to an ion guide DC offset may be applied to the first and second gating electrodes; and
in a gating mode the gating DC voltage is applied to the first gating electrode and the passing DC voltage may be applied to the second gating electrode.

The second electrode assembly may comprise a first gating electrode and a second gating electrode, wherein:
in a passing mode the passing DC voltage with respect to an ion guide DC offset may be applied to the first gating electrode and to the second gating electrode with the same polarity; and
in a gating mode the gating DC voltage is applied to the first gating electrode with a first polarity and the gating DC voltage may be applied to the second gating electrode with a second polarity opposite to the first polarity.

Aspects of the disclosure are provided by the following numbered clauses:

Clause 1. An ion gate for a mass spectrometer, the ion gate comprising:
a first electrode assembly comprising a plurality of guide electrodes aligned along a central axis, wherein:
the plurality of guide electrodes are arranged to define a multipole ion guide from a first end of the first electrode assembly to a second end of the first electrode assembly;
the ion guide is configured to receive an ion beam at the first end; and
the plurality of guide electrodes are configured to receive RF voltages to define a confinement volume for the ion beam, wherein the confinement volume is centred about the central axis; and
a second electrode assembly comprising at least one gating electrode positioned:
adjacent to the first electrode assembly;
outside of the confinement volume; and
at a first axial distance from the first end of the first electrode assembly and at a second axial distance from the second end of the first electrode assembly
wherein the at least one gating electrode is configured to receive a DC voltage that is changeable between:
a passing DC voltage such that the ion beam is transmitted along the ion guide; and
a gating DC voltage such that the ion beam is prevented from transmission along the ion guide.

Clause 2. The ion gate of clause 1, wherein the gating electrode intersects a first guide electrode of the plurality of guide electrodes.

Clause 3. The ion gate of clause 2 wherein the first guide electrode is shaped such the first guide electrode does not fully shield the electric field of the gating electrode.

Clause 4. The ion gate of clause 2 or 3 wherein the first guide electrode comprises a slot configured to accommodate the gating electrode.

Clause 5. The ion gate of any preceding clause, wherein each of the plurality of guide electrode is symmetrical along a linear axis.

Clause 6. The ion gate of any preceding clause wherein each of the plurality of guide electrodes comprises a rod electrode.

Clause 7. The ion gate of clause 5 or 6, wherein each of the plurality of guide electrodes has cylindrical symmetry.

Clause 8. The ion gate of clause 5 wherein each of the plurality of guide electrodes has a rectangular cross-section.

Clause 9. The ion gate of clause 8 wherein the plurality of ion guide electrodes comprises:
a first guide electrode and a second guide electrode, wherein the first guide electrode opposes the second guide electrode; and
a primary guide electrode assembly and a secondary guide electrode assembly, wherein the primary guide electrode assembly opposes the secondary guide electrode assembly;
wherein the primary guide electrode assembly comprises a first sheet electrode and a second sheet electrode, and the secondary guide electrode assembly comprises a third sheet electrode and a fourth sheet electrode.

Clause 10. The ion gate of clause 9 wherein the gating electrode intersects the first sheet electrode and the second sheet electrode.

Clause 11. The ion gate of any preceding clause further comprising one or more additional DC bias electrodes configured to provide an axial DC field, wherein the one or more DC bias electrodes are adjacent to the first electrode assembly and wherein the gating electrode intersects the one or more DC bias electrodes.

Clause 12. The ion gate of any preceding clause wherein the multipole ion guide is a quadrupole.

Clause 13. The ion gate of any preceding clause wherein the plurality of guide electrodes are centred around the central axis.

Clause 14. The ion gate of any preceding clause wherein the gating electrode is symmetrical along a linear axis.

Clause 15. The ion gate of clause 14 wherein the gating electrode has cylindrical symmetry.

Clause 16. The ion gate of clause 14 or 15 wherein the linear axis of the gating electrode is perpendicular to the central axis.

Clause 17. The ion gate of any preceding clause wherein the second electrode assembly comprises a first gating electrode and a second gating electrode.

Clause 18. The ion gate of any preceding clause, wherein in an event that the gating electrode receives a gating DC voltage, the ion beam is deflected laterally away from the central axis and out of the confinement volume.

Clause 19. The ion gate of any of clauses 1 to 17, wherein in an event that the gating electrode receives a gating DC voltage, the ion beam is stored within the confinement volume.

Clause 20. An ion guide comprising the ion gate of any preceding clause.

Clause 21. A mass spectrometer comprising an ion guide, wherein the ion guide comprises a first ion gate according to any of clauses 1 to 19.

Clause 22. The mass spectrometer of clause 21 further comprising a second ion gate.

Clause 23. The mass spectrometer of clause 22 wherein the second ion gate is positioned upstream of the first ion gate such that an ion beam reaches the second ion gate before the first ion gate and wherein a response time of the second ion gate is slower than a response time of the first ion gate.

Clause 24. The mass spectrometer of clause 22 wherein the second ion gate is positioned downstream of the first ion gate such that an ion beam reaches the second ion gate after the first ion gate and wherein a response time of the second ion gate is faster than a response time of the first ion gate.

Clause 25. A method of controlling transmission of an ion beam through an ion gate in a mass spectrometer, wherein the ion gate comprises:
a first electrode assembly comprising a plurality of guide electrodes aligned along a central axis, wherein:
the plurality of guide electrodes are arranged to define a multipole ion guide from a first end of the first electrode assembly to a second end of the first electrode assembly; and
the ion guide is configured to receive an ion beam at the first end; and
a second electrode assembly comprising at least one gating electrode positioned:
adjacent to the first electrode assembly;
outside of the confinement volume; and
at a first axial distance from the first end of the electrode assembly and at a second axial distance from the second end of the first electrode assembly;
the method comprising:
applying RF voltages to the plurality of guide electrodes to define a confinement volume for the ion beam, wherein the confinement volume is centred about the central axis;
allowing transmission of the ion beam by applying a passing DC voltage to the at least one gating electrode such that the ion beam is transmitted along the ion guide; and
preventing transmission of the ion beam by applying a gating DC voltage to the at least one gating electrode such that the ion beam is prevented from transmission along the ion guide.

Clause 26. The method of clause 25 wherein applying the gating DC voltage to the gating electrode attracts the ion beam such that the ion beam is deflected towards a gating electrode.

Clause 27. The method of clause 25 or 26 wherein the second electrode assembly comprises a first gating electrode and a second gating electrode and wherein:
in a passing mode the passing DC voltage with respect to an ion guide DC offset is applied to the first and second gating electrodes; and
in a gating mode the gating DC voltage is applied to the first gating electrode and the passing DC voltage is applied to the second gating electrode.

Clause 28. The method of clause 25 or 26 wherein the second electrode assembly comprises a first gating electrode and a second gating electrode and wherein: in a passing mode the passing DC voltage with respect to an ion guide DC offset is applied to the first gating electrode and to the second gating electrode with the same polarity; and in a gating mode the gating DC voltage is applied to the first gating electrode with a first polarity and the gating DC voltage is applied to the second gating electrode with a second polarity opposite to the first polarity.

### BRIEF DESCRIPTION OF THE DRAWINGS

A specific embodiment of the disclosure will now be described, by way of example only, with reference to the accompanying drawings in which:

FIG. 1 shows a schematic diagram of an ion gate according to an embodiment of the present disclosure.

FIG. 2 shows a schematic diagram of a cross-sectional view ion gate according to an embodiment of the present disclosure.

FIG. 3 shows a schematic diagram of a top view ion gate according to an embodiment of the present disclosure.

FIG. 4 shows a graph of the radial trapping potential plotted against the distance x towards the central axis of the ion guide for the ion guide of FIGS. 2 and 3.

FIG. 5 shows a schematic diagram of a cross-sectional view of the ion gate according to an embodiment of the present disclosure.

FIG. 6 shows a schematic diagram of a top view of the ion gate according to an embodiment of the present disclosure.

FIG. 7 shows a graph of the radial trapping potential plotted against the distance x towards the central axis of the ion guide for the ion guide of FIGS. 5 and 6.

FIG. 8 shows a schematic diagram of a cross-sectional view of the ion gate according to an embodiment of the present disclosure.

FIG. 9 shows a schematic diagram of a top view of the ion gate according to an embodiment of the present disclosure.

FIG. 10 shows pressure within an ion gate as a function of axial distance according to an embodiment of the present disclosure as used in a simulation.

FIG. 11 shows simulation results for an ion beam passing through an ion gate according to an embodiment of the present disclosure. FIG. 11A shows the ion gate in a passing mode; FIG. 11B shows an attractive potential of −30V applied to a gating electrode relative to the ion guide potential; FIG. 11C shows an attractive potential of −40V applied to a gating electrode relative to the ion guide potential; and FIG. 11D shows an attractive potential of −μ50V applied to a gating electrode relative to the ion guide potential.

FIG. 12 shows gating potentials plotted against m/z according to simulations for an ion gate according to an embodiment of the present disclosure.

FIG. 13 shows simulation results of ion transmission along the z axis plotted for an ion gate according to an embodiment of the present disclosure in a passing mode and a gating mode.

FIG. 14 shows simulation results of fractions of ion transmission plotted against fraction of time in the passing mode for an ion gate according to an embodiment of the present disclosure.

FIG. 15 shows spectra of an ion beam that has passed through an ion gate according to an embodiment of the present disclosure.

FIG. 16 shows a schematic diagram of an ion gate according to an embodiment of the present disclosure. FIG. 16A shows a gating electrode at 45° to the vertical, and FIG. 16B shows a radial gating electrode.

FIG. 17 shows a schematic diagram of an ion gate according to an embodiment of the present disclosure. FIG. 17A shows a guide electrode having a slot, and FIG. 17B shows a guide electrode having an aperture.

### DETAILED DESCRIPTION

According to an embodiment of the present disclosure, an ion gate for a spectrometer is provided. The ion gate is configured to provide for control over the transmission of an ion beam, such that transmission of the ion beam can be prevented or allowed. As an example, an ion gate may be used in a spectrometer that has a continuous or quasi-continuous ion source. For example, an electrospray ionisation source, electron impact ionisation source or chemical ionisation source may be used. To obtain reproducible and quantitative results when the ions are analysed, well-defined portions of the ion beam should be sampled. The ions may be passed from the ion source to an ion trap, in which ions are accumulated. An ion gate may be used to control the population of ions passing into the ion trap. The ions may then be analysed within the ion trap or may be passed on to downstream components for analysis. An ion gate may be used to control the transmission of an ion beam at other stages of a spectrometer.

According to an embodiment of the present disclosure, an ion gate comprises a first electrode assembly comprising a plurality of guide electrodes aligned along a central axis. The plurality of guide electrodes are arranged to define a multipole ion guide from a first end of the first electrode assembly to a second end of the first electrode assembly. Each guide electrode may be continuous from the first end of the first electrode assembly to the second end of the first electrode assembly. The ion guide is configured to receive an ion beam at the first end. The plurality of guide electrodes are configured to receive radio frequency (RF) voltages to define a confinement volume for the ion beam, wherein the confinement volume is centred about the central axis. The ion gate further comprises a second electrode assembly comprising at least one gating electrode. The gating electrode or gating electrodes may each intersect a guide electrode such that the guide electrode is continuous around the gating electrode in a direction parallel to the central axis. The at least one gating electrode is positioned adjacent to the first electrode assembly and outside of the confinement volume. The at least one gating electrode is positioned between the first end of the first electrode assembly and the second end of the first electrode assembly. The at least one gating electrode may be positioned at a first axial distance from the first end of the first electrode assembly and at a second axial distance from the second end of the first electrode assembly. The at least one gating electrode is configured to receive a DC voltage that is changeable between a passing DC voltage and a gating DC voltage. The passing DC voltage is such that the ion beam is transmitted along the ion guide. The gating DC voltage is such that the ion beam is prevented from transmission along the ion guide. The DC voltages described herein may be with respect to an ion guide DC offset.

Several embodiments of the ion gate will be described. The ion gates described herein may be incorporated into ion guides that extend upstream and/or downstream of the ion gate. The ion gate may be used without an ion guide extending upstream or downstream of the ion gate, or with an ion guide extending only upstream of the ion gate, or with an ion guide extending only downstream of the ion gate, or with an ion guide extending both upstream and downstream of the ion gate. The ion guide may be continuous with the ion gate, wherein the first electrode assembly extends to provide the ion guide. The ion guide may be separate to the ion guide, wherein the ion guide is formed from electrodes separate to the first electrode assembly.

The position of the at least one gating electrode adjacent to the first electrode assembly may be such that the at least one gating electrode intersects one or more electrodes of the first electrode assembly. The position of the at least one gating electrode as measured on the central axis is between the positions of the first end and the second end of the first electrode assembly as measured on the central axis. The first axial distance of the at least one gating electrode from the first end of the first electrode assembly may be different to or the same as the second axial distance of the at least one gating electrode from the second end of the first electrode assembly. The radial distance of the at least one gating electrode from the central axis may be smaller than, equal to or greater than the radial distance of the first electrode assembly from the central axis. The radial distance of the at least one gating electrode from the central axis may be no less than half the radial distance of the first electrode assembly from the central axis. The at least one gating electrode may, as a result, be outside of the confinement volume (in other words, the at least one gating electrode may be outside of the ion path). The radial distance of the at least one gating electrode from the central axis may be greater than the radial distance of the first electrode assembly from the central axis. The at least one gating electrode is positioned radially outside of the confinement volume.

The at least one gating electrode may be positioned outside of a central volume. The central volume may extend from the central axis to a surface of each of the plurality of guide electrodes that is closest to the central axis. The central volume may be centred about the central axis.

In an embodiment, the at least one gating electrode may be integrated into the first electrode assembly. The at least one gating electrode may be positioned such that the guide electrodes do not fully shield the gating electrode(s) such that the electric field of the gating electrode penetrates the confinement volume towards or as far as the central axis. in an example, there may be line-of-sight between at least part of the gating electrode(s) and the central axis. For example, a gap in the guide electrodes may allow the electric field of the gating electrode to penetrate the confinement volume towards or as far as the central axis.

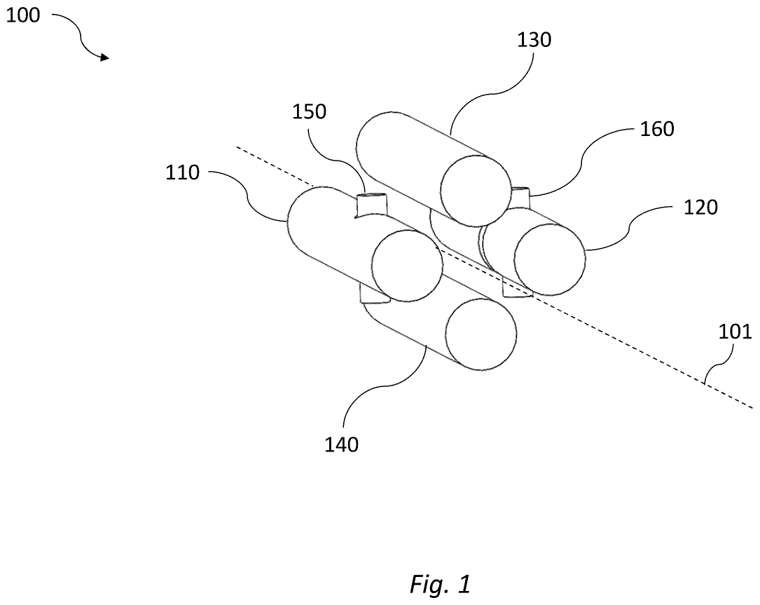

In a certain embodiment, a gating electrode may be positioned in a slot or recess of a guide electrode. With reference to FIG. 1, an example of an ion gate 100 according to an embodiment of the present disclosure is shown wherein the first electrode assembly comprises a quadrupole. The first electrode assembly comprises first, second, third and fourth guide electrodes 110, 120, 130, 140 parallel to the central axis 101 and spaced equally around the central axis 101. A first guide electrode 110 comprises a first slot in the side of the first guide electrode 110 closest to the central axis, wherein the first slot is configured to accommodate a first gating electrode 150. The first guide electrode 110 is continuous around the first gating electrode 150 in a direction parallel to the central axis 101. In other words, the slot does not pass through the whole cross-section of the first guide electrode, such that the first guide electrode 110 does not have a break at the first gating electrode 150. A second guide electrode 120 opposing the first guide electrode comprises a second slot in the side of the second guide electrode closest to the central axis, wherein the second slot is configured to accommodate a second gating electrode 160 such that the second gating electrode 160 is opposite to the first gating electrode 150. The second guide electrode 120 is continuous around the second gating electrode 160 in a direction parallel to the central axis 101. A third guide electrode 130 between the first guide electrode 110 and the second guide electrode 120 does not comprise a slot. A fourth guide electrode 140 opposite to the third guide electrode 130 does not comprise a slot. The first, second, third and fourth guide electrodes 110, 120, 130, 140 are configured to receive RF voltages to define a confinement volume for the ion beam. In a passing mode, the first gating electrode 150 and the second gating electrode 160 receive a passing DC voltage. The passing DC voltage comprises a pulsed DC voltage applied to the first and second gating electrodes 150, 160 such that the radially confining RF potential of the first electrode assembly is minimally disrupted and ions are transmitted through the ion guide. In a gating mode, the first gating electrode 150 and the second gating electrode 160 each receive a gating DC voltage. The gating DC voltages comprise a pulsed DC voltages applied to the first and second gating electrodes 150, 160 such that the ions are deflected laterally away from the central axis 101 and across the radially confining potential barrier of the RF field. As a result, the ions are effectively removed from the ion guide, preventing transmission of the ion beam along the ion guide.

The central volume may be centred about the central axis 101, and may extend to inner surfaces of the guide electrodes 110, 120, 130 and 140 such that a radius of the central volume is the same as the smallest radial distance between the central axis 101 and the guide electrodes 110, 120, 130 and 140.

The first electrode assembly of the ion gate 100 shown in FIG. 1 comprises a quadrupole comprising cylindrical rod electrodes, each electrode having a longitudinal axis parallel to the central axis. In certain embodiments, the first electrode assembly may comprise fewer than four electrodes or more than four electrodes arranged around the central axis. In certain embodiments, the first electrode assembly may comprise electrodes having other geometries, such as electrodes with hyperbolic or rectangular cross-sections. In certain embodiments, the first electrode assembly may comprise electrodes having longitudinal axes that are not parallel to the central axis.

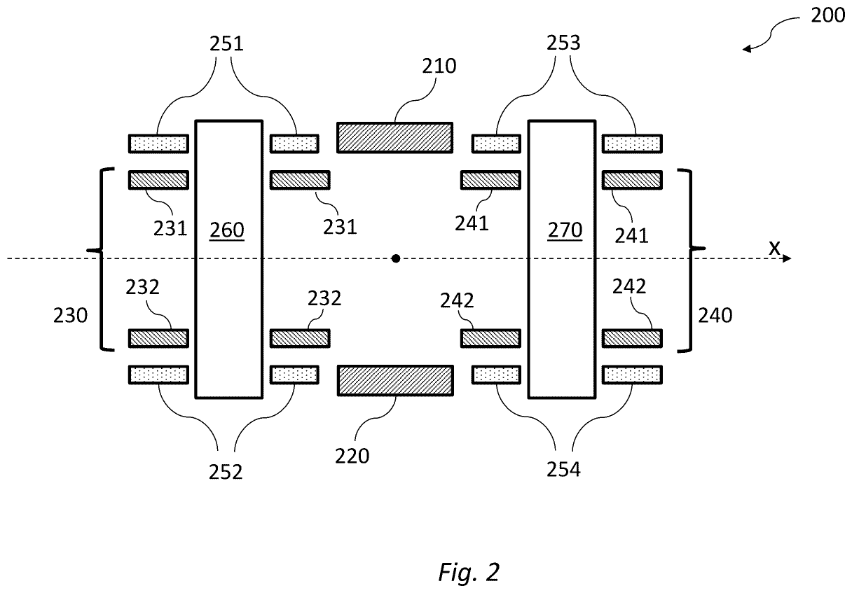

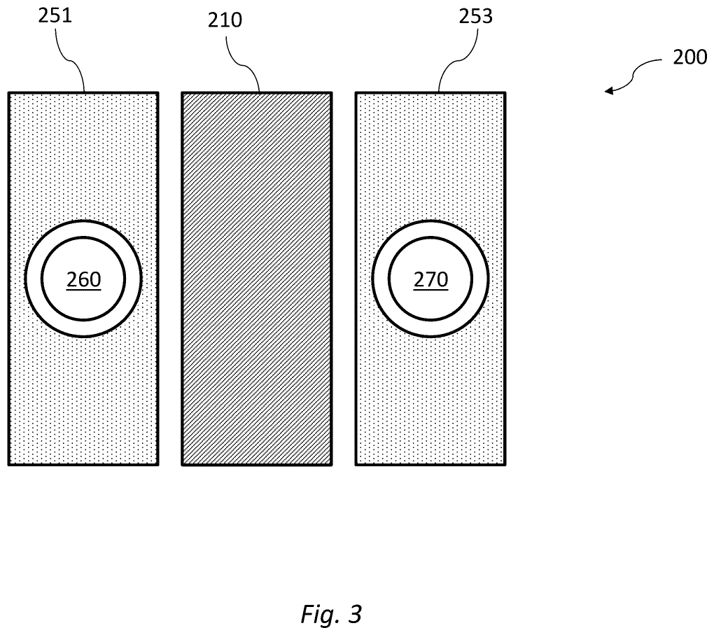

With reference to FIGS. 2 and 3, another example of an ion gate 200 according to an embodiment of the present disclosure is shown wherein the first electrode assembly comprises a quadrupole with rectangular electrode cross-section. FIG. 2 shows a cross-section of the ion gate 200, taken in a plane perpendicular to the central axis. A first opposing pair of RF electrodes RF1 comprises a first guide electrode 210 and a second guide electrode 220, wherein both the first guide electrode 210 and the second guide electrode 220 have a rectangular cross-section. A second opposing pair of RF electrodes RF2 comprises a primary guide electrode assembly 230 and a secondary guide electrode assembly 240. The primary guide electrode assembly 230 comprises a first sheet electrode 231 and a second sheet electrode 232. Similarly, the secondary guide electrode assembly 240 comprises a third sheet electrode 241 and a fourth sheet electrode 242. The first, second, third and fourth sheet electrodes 231, 232, 241 and 242 may each have a rectangular cross-section. RF1 and RF2 may be arranged symmetrically around the central axis.

The ion gate 200 further comprises a first gating electrode 260 and a second gating electrode 270. The first and second gating electrodes 260 and 270 may pass through apertures in the first, second, third and fourth sheet electrodes 231, 232, 241 and 242. The first and second gating electrodes 260 and 270 may comprise rod electrodes with circular cross-sections. The first, second, third and fourth sheet electrodes 231, 232, 241 and 242 may each be continuous about the first and second gating electrodes 260 and 270 in a direction parallel to the central axis (similarly to the arrangement shown in FIG. 3 for the DC bias electrodes).

The first electrode assembly of ion gate 200 is configured to receive RF voltages to define a confinement volume for the ion beam, wherein the confinement volume is centred about the central axis. In a passing mode, the first gating electrode 260 and the second gating electrode 270 receive a passing DC voltage. The passing DC voltage comprises a pulsed DC voltage applied to the first and second gating electrodes 260, 270 such that the radially confining RF potential of the first electrode assembly is minimally disrupted and ions are transmitted through the ion guide. In a gating mode, the first gating electrode 260 and the second gating electrode 270 receive a gating DC voltage. The gating DC voltage comprises a pulsed DC voltage applied to the first and second gating electrodes 260, 270 such that the ions are deflected laterally away from the central axis and across the radially confining potential barrier of the RF field. The gap between the first and the second sheet electrodes 231 and 232 and the gap between the third and the fourth sheet electrodes 241 and 242 allow the electric field of the gating electrodes to penetrate towards the central axis.

In certain embodiments, the ion gate 200 may further comprise DC bias electrodes 251, 252, 253 and 254. The DC bias electrodes 251, 252, 253 and 254 may comprise sheet electrodes arranged adjacent to the primary and secondary guide electrode assemblies 230 and 240, such that the primary guide electrode assembly 230 is between DC bias electrodes 251 and 252, and the secondary guide electrode assembly 240 is between DC bias electrodes 253 and 254. The first gating electrode 260 may pass through apertures in DC bias electrodes 251 and 252, and the second gating electrode 270 may pass through apertures in DC bias electrodes 253 and 254. FIG. 3 shows a top view of the ion gate 200, showing the first guide electrode 210, the first gating electrode 260 passing through an aperture in DC bias electrode 251, and the second gating electrode 270 passing through an aperture in DC bias electrode 253. The DC bias electrodes 251, 252, 253 and 254 may, for example, be used to apply an axial field gradient onto the radially confining RF potential of the first electrode assembly. Such an axial field gradient can assist in moving ions along the ion guide. To achieve this, the DC bias electrodes 251, 252, 253 and 254 may comprise wedge shaped electrodes (wherein the thickness varies in a direction parallel to the central axis), and/or the distance of the DC bias electrodes 251, 252, 253 and 254 from the central axis may vary along the central axis. Other embodiments of the ion guide may comprise one or more DC bias electrodes configured to provide an axial DC field. The one or more DC bias electrodes may be adjacent to the first electrode assembly. The one or more gating electrodes may intersect the one or more DC bias electrodes. Similarly to the arrangement of the sheet electrodes, the DC bias electrodes 251, 252, 251 and 252 may each be continuous about the first and second gating electrodes 260 and 270 in a direction parallel to the central axis.

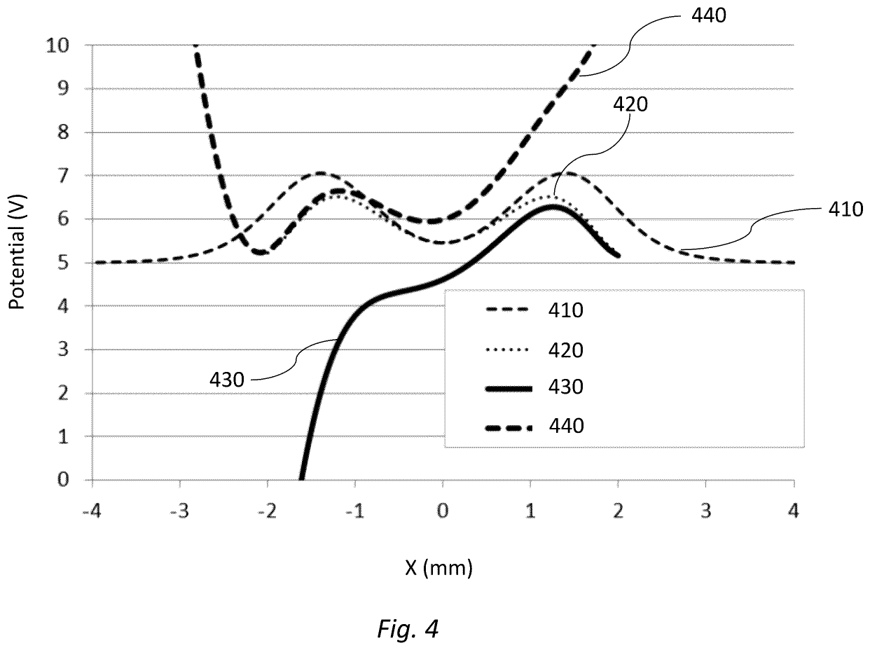

With reference to FIG. 4, results of a simulation of the potential within the ion gate 200 illustrated in FIGS. 2 and 3 are shown. The radial trapping potential is plotted against the x axis, which is indicated in FIG. 2 by the dashed arrow. The x axis has an origin at the central axis of the ion guide, and bisects the first and second gating electrodes 260, 270. The simulations use an RF amplitude and frequency chosen such that ions with mass/charge ratio (m/z) 524 have a trapping parameter of approximately q=0.2. This provides a trapping potential depth of approximately 1.5 V. However, it will be understood that the precise values used in the simulation are merely examples. The shapes of the potentials shown in FIG. 4 would occur for other RF amplitudes and frequencies.

In FIG. 4, the thin dashed line 410 shows the effective radial trapping potential in an ion guide similar to ion gate 200 but without gating pins present. The trapping potential depth is approximately 1.5 V in this example, and is centred at x=0. The trapping potential includes both the RF trapping potential and the DC potential applied by DC bias electrodes 251, 252, 253 and 254. For each of lines 420, 430 and 440 plotted in FIG. 4, the same voltages are applied to the guide electrodes and to the DC bias electrodes as for line 410. The dotted line 420 indicates the trapping potential in an ion gate 200 in passing mode, wherein the first and second gating electrodes 260, 270 receive a passing DC voltage. The passing DC voltage is the DC potential of the ion gate 200. Near to the first and second gating electrodes 260 and 270, the RF field is disturbed and the trapping potential is reduced by approximately one third (i.e. by approximately 0.5 V). The solid line 430 indicates the potential when the first gating electrode 260 receives an attractive potential of −30V (for positive ions) with respect to the DC potential of the ion gate 200. The voltage is sufficient to overcome the trapping potential for ions with m/z 524 under the simulation conditions. As a result, the ions would be deflected laterally away from the central axis and out of the confinement volume, effectively removing the ions from the ion guide and preventing transmission of the ion beam along the ion guide. The thick dashed line 440 indicates the potential when the second gating electrode 270 receives a repulsive potential of +30V (for positive ions) with respect to the DC potential of the ion gate 200. While the trapping potential is disturbed, it is not fully overcome. An attractive potential is more efficient for deflecting the ion beam.

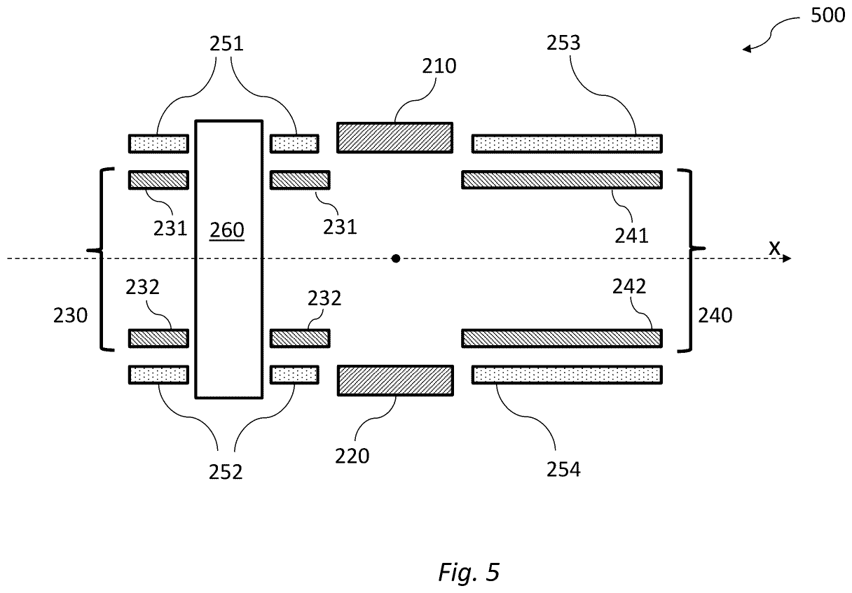

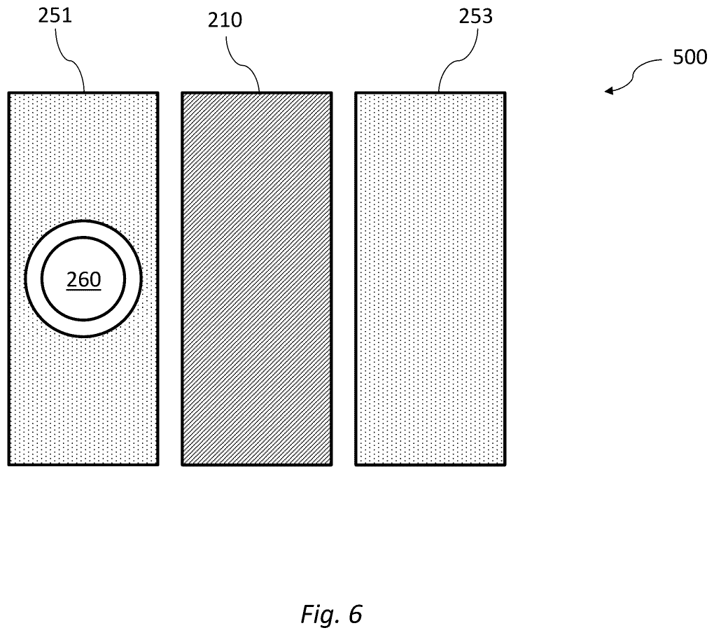

FIGS. 5 and 6 show an ion gate 500 that is similar to ion gate 200 shown in FIGS. 2 and 3, but without the second gating electrode 270. Like reference numerals indicate like features.

FIG. 5 shows a cross-section of ion gate 500 in a plane perpendicular to the central axis, and FIG. 6 shows a top view of ion gate 500. A first opposing pair of RF electrodes RF1 comprises a first guide electrode 210 and a second guide electrode 220, wherein both the first guide electrode 210 and the second guide electrode 220 have a rectangular cross-section. A second opposing pair of RF electrodes RF2 comprises a primary guide electrode assembly 230 and a secondary guide electrode assembly 240. The primary guide electrode assembly 230 comprises a first sheet electrode 231 and a second sheet electrode 232. Similarly, the secondary guide electrode assembly 240 comprises a third sheet electrode 241 and a fourth sheet electrode 242. The first, second, third and fourth sheet electrodes 231, 232, 241 and 242 may each have a rectangular cross-section. RF1 and RF2 may be arranged symmetrically around the central axis. The ion gate 500 further comprises a first gating electrode 260. The first gating electrode 260 may pass through apertures in the first and second sheet electrodes 231, 232. The first gating electrode 260 may comprise a rod electrode with a circular cross-section. In certain embodiments, the ion gate 500 may further comprise DC bias electrodes 251, 252, 253 and 254.

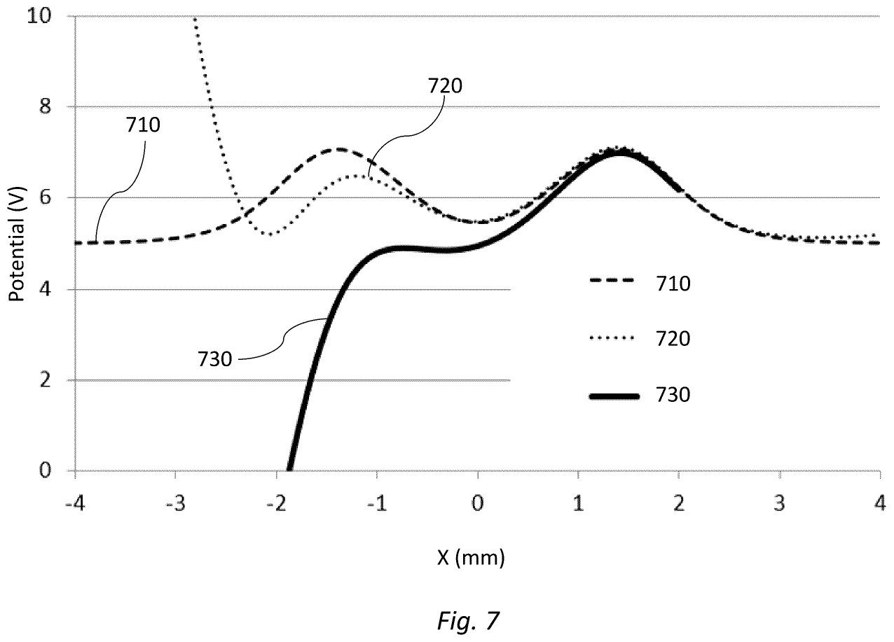

With reference to FIG. 7, results of a simulation of the radial trapping potential within the ion gate 500 illustrated in FIGS. 5 and 6 are shown. The potential is plotted against the x axis, which is indicated in FIG. 5 by the dashed arrow. The x axis has an origin at the central axis of the ion guide, and bisects the first gating electrode 260. The simulations use an RF amplitude and frequency chosen such that ions with mass/charge ratio (m/z) 524 have a trapping parameter of approximately q=0.2. This provides a trapping potential depth of approximately 1.5 V. However, it will be understood that the precise values used in the simulation are merely examples. The shapes of the potentials shown in FIG. 7 would occur for other RF amplitudes and frequencies.

In FIG. 7, the thin dashed line 710 shows the effective radial trapping potential in an ion gate similar to ion gate 500 but without gating pins present. The trapping potential depth is approximately 1.5 V in this example, and is centred at x=0. The trapping potential includes both the RF trapping potential and the DC potential applied by DC bias electrodes 251, 252, 253 and 254. For each of lines 720, 730 and 740 plotted in FIG. 7, the same voltages are applied to the guide electrodes and to the DC bias electrodes as for line 710. The dotted line 720 indicates the trapping potential in an ion gate 500 in passing mode, wherein the first gating electrode 260 receives a passing DC voltage. The passing DC voltage is the DC potential of the ion gate 500. Near to the first gating electrode 260, the RF field is disturbed and the trapping potential is reduced by approximately one third (i.e. by approximately 0.5 V). In the absence of the second gating electrode 270, the RF field is relatively undisturbed at positive x values. The solid line 730 indicates the potential when the first gating electrode 260 receives an attractive potential of −30V (for positive ions) with respect to the DC potential of the ion gate 500. The voltage is sufficient to overcome the trapping potential for ions with m/z 524 under the simulation conditions. Again, in the absence of the second gating electrode 270, the RF field is relatively undisturbed at positive x values.

As shown by these simulations, a single gating electrode is sufficient to overcome the trapping potential and deflect the ions away from the central axis and out of the confinement volume. In other embodiments, the gating voltages applied to first and second gating electrodes 260 and 270 of ion gate 200 (or, indeed, any other geometry of ion gate having first and second gating electrodes) may have opposite polarities. In this way, the DC amplitudes required to fully deflect the ions in the gating mode is reduced.

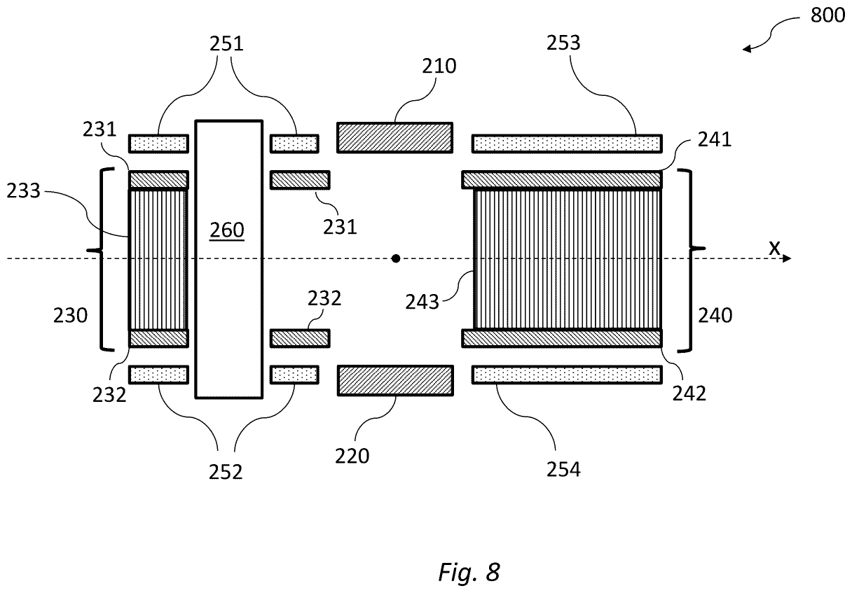

With reference to FIG. 8, an ion gate 800 is illustrated according to an embodiment of the present disclosure. The ion gate 800 is similar to the ion gate 500 shown in FIGS. 5 and 6. Like reference numerals indicate like features. The primary electrode assembly 230 of the ion gate 800 further comprises a third electrode 233 between the first and second sheet electrodes 231, 232 of the primary guide electrode assembly 230. The third electrode 233 may be at a radial distance from the central axis that is larger than the radial distance of the gating electrode 260 from the central axis, such that the gating electrode 260 is adjacent to the electrode 233. The third electrode 233 may be adjacent to the first and second sheet electrodes 231, 232. The third electrode 233 may have contact with the first and second sheet electrodes 231, 232, or there may be a gap between the third electrode 233 and the first and second sheet electrodes 231, 232. The secondary electrode assembly 240 of the ion gate 800 further comprises a fifth electrode 243 between the third and fourth sheet electrodes 241, 242 of the secondary guide electrode assembly 240. The fifth electrode 243 may have contact with the third and fourth sheet electrodes 241, 242, or there may be a gap between the fifth electrode 243 and the third and fourth sheet electrodes 241, 242.

In certain embodiments, the distance of one or more gating electrodes from the central axis may be optimised. A smaller distance between the gating electrode(s) from the central axis reduces the trapping potential in the passing mode. A larger distance between the gating electrode(s) and the central axis requires the gating electrode(s) to receive a larger DC amplitude in the gating mode in order to overcome the trapping potential. The trade-off between these two effects can be used to determine the distance of one or more gating electrodes from the central axis.

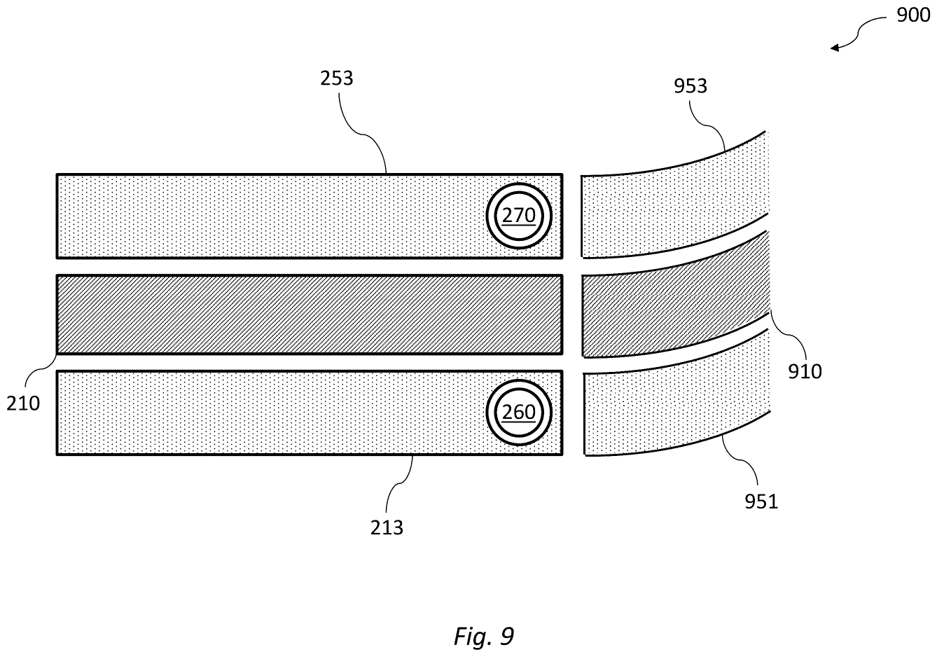

In certain embodiments, the ion guide may comprise a curved section downstream of the gating electrodes. With reference to FIG. 9, a top view of an ion guide 900 is shown with a linear section similar to the ion gate of FIGS. 2 and 3, wherein the ion guide is linear upstream of and at the gating electrodes 260, 270. A cross-sectional view of the ion guide 900 taken through the gating electrodes 260 and 270 would be the same as that illustrated in FIG. 2. Downstream of the gating electrodes 260 and 270, the ion guide 900 is curved. Curved sections of the DC bias electrodes 951 and 953 and a curved section of the first guide electrode 910 are shown. The other DC bias electrodes and guide electrodes also have curved sections, not shown, in the same cross-sectional configuration as for the linear sections. In certain embodiments, the linear sections and the curved sections of the electrodes may be continuous. In certain embodiments, there may be a break between the linear sections and the curved sections of the electrodes. The ion beam may enter the ion guide 900 via the linear section of the ion guide 900, for example from an ion funnel.

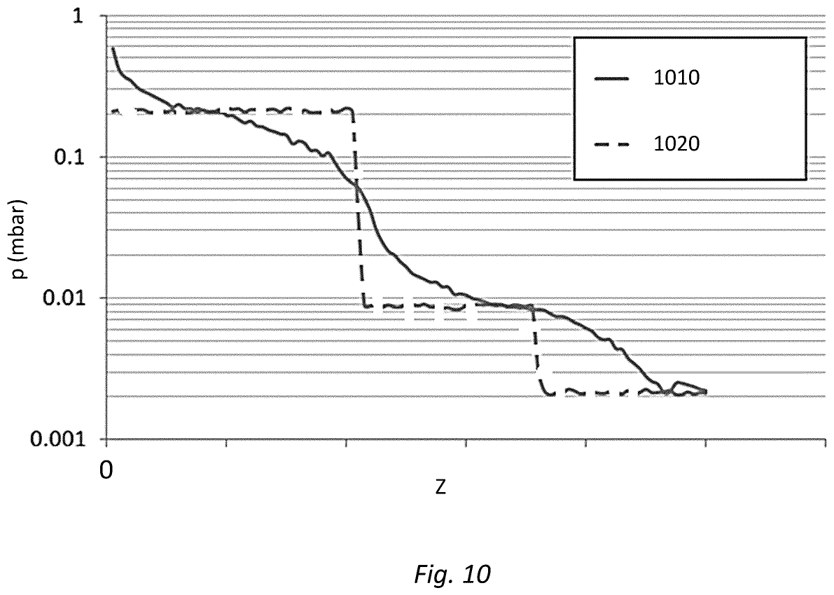

With reference to FIGS. 10 to 12, results of a further simulation of the potential within the ion guide 900 illustrated in FIG. 9 is shown. The simulations use an RF amplitude and frequency chosen such that ions with mass/charge ratio (m/z) 524 have a trapping parameter of approximately q=0.2. This provides a trapping potential depth of approximately 1.5 V. However, it will be understood that the precise values used in the simulation are merely examples. The simulation includes local gas pressure along the ion guide. FIG. 10 shows the applied pressure used in the simulation, plotted on a logarithmic scale against z (where the z axis is parallel to the central axis). This is an example only, and other pressure values or distributions may be used. The solid line 1010 shows the applied pressure profile as a function of axial distance along the z-axis. The dashed line 1020 shows the average pressure in sections of the ion guide. At z=0, the pressure is set to be 1.5 mbar. z=0 may be the end of an ion funnel and the start of the ion guide. The pressure within the ion funnel may be 1.5 mbar. In this simulation, the pressure in a first part of the ion guide is 0.2 mbar, the pressure in a second part of the linear ion guide is 0.01 mbar, and the pressure in a third part of the ion guide is 2E-3 mbar. The first and second parts of the ion guide are linear. The third part of the ion guide includes the gating electrodes 260 and 270 and a curved section of the ion guide, as indicated in FIG. 9.

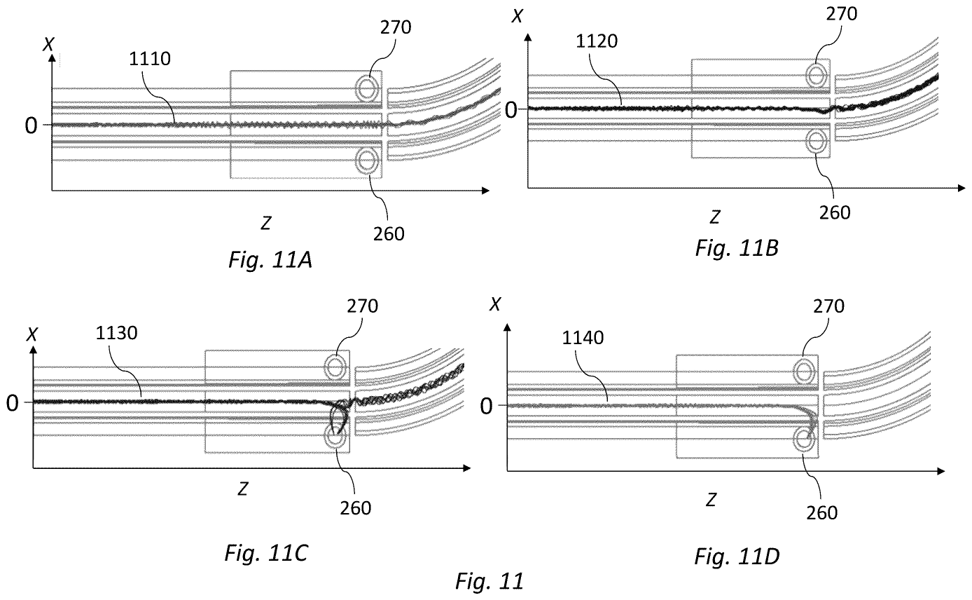

Results of the simulation are shown in FIG. 11. The path of a beam of positively charged ions with m/z 524 is plotted over a top view of the ion guide 900, with x plotted against z. Downstream of the gating electrodes 260 and 270, the ion beam is centred around x=0. FIG. 11A shows the path of the ion beam 1110 when the gating electrodes 260 and 270 are set to the DC potential of the linear ion guide (i.e. in passing mode), referred to as the “offset” value. The ion beam remains within the ion guide, and is centred within the ion guide. FIG. 11B shows the path of the ion beam 1120 when one of the gating electrodes 270 is set to the offset value and the other gating electrode 260 is set to an attractive potential of around −30 V with respect to the offset value. The ion beam is only slightly deflected, and remains within the ion guide. FIG. 11C shows the path of the ion beam 1120 when one of the gating electrodes 270 is set to the offset value and the other gating electrode 260 is set to an attractive potential of around −40 V with respect to the offset value. The ion beam 1130 is partially deflected and partially transmitted. The part of the ion beam that is deflected is deflected towards gating electrode 260, away from the curvature of the ion guide. FIG. 11D shows the path of the ion beam 1140 when one of the gating electrodes 270 is set to the offset value and the other gating electrode 260 is set to an attractive potential of around −50 V with respect to the offset value. The ion beam 1140 is fully deflected, with no ions being transmitted along the ion guide beyond the gating electrodes. The ion beam is deflected towards gating electrode 260, away from the curvature of the ion guide. As shown in the FIGS. 11C and 11D, the arrival point of deflected ions (at which the ions impinge on the gating electrode) is expected to be at an area at the rear side of the deflecting electrode that is “shadowed” from the ion optical axis. This may be achieved by tuning the gating voltage appropriately. In this way, the potential on the ion guide axis is minimally disturbed by the resulting charge up, which helps to increase the time before cleaning becomes necessary.

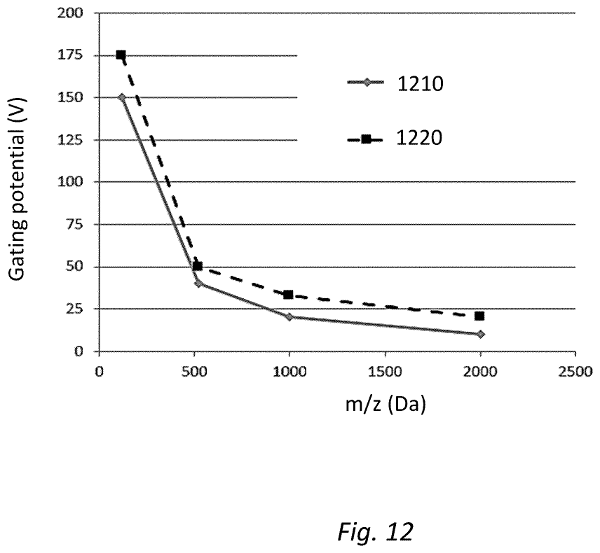

FIG. 12 shows the results of repeating these simulations for ions of other m/z ratios. The absolute value of the potential applied to gating electrode 260 is plotted against m/z, where gating electrode 270 is kept at the offset value. The solid line 1210 shows the voltage applied to the gating electrode 260 to achieve onset of ion beam deflection. The dashed line 1220 shows the minimum voltage applied to the gating electrode 260 to achieve full deflection of the ion beam. The minimum voltage required to achieve full deflection scales approximately as (m/z)⁻¹.

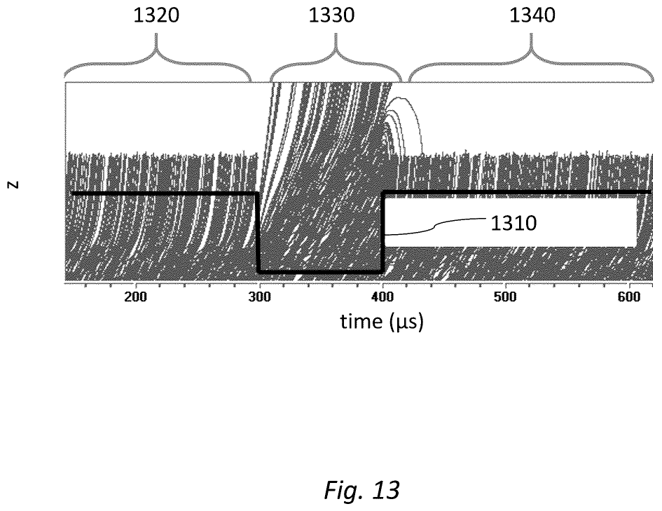

Further simulations were carried out to estimate the speed at which the ion beam changes from being deflected or transmitted when the gating electrodes are changed between the gating and the passing mode. The simulations were carried out for an ion guide having one gating electrode 260, such as the ion gate 500 illustrated in FIGS. 5 and 6. With reference to FIG. 13, the axial component of the ion trajectory is plotted as a function of time. The ions in a particle tracing simulation were launched continuously over the time period of the simulation. The gating electrode was set to the gating mode, such that the ions are not transmitted beyond z=93 mm. The gating electrode was set to −100 V with respect to the offset value. The gating electrode was changed to the passing mode (i.e. set to the offset value) for 0.1 ms, as indicated by the rectangular gating pulse 1310 shown by the solid black line. The gating electrode is therefore operating in the gating mode in time periods 1320 and 1340, and in the passing mode in time period 1330.

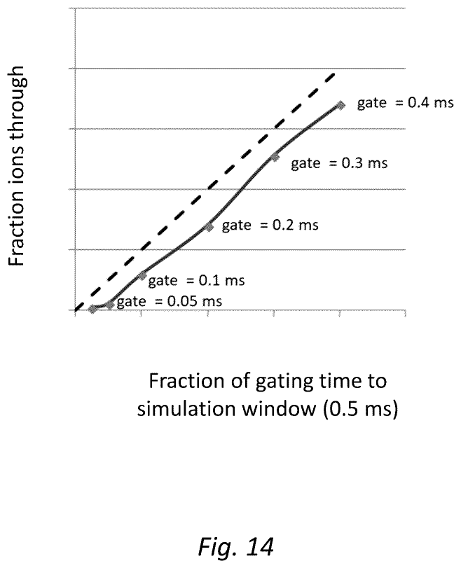

The ions being transmitted during the time period 1330 were counted, as a fraction of the total number of ions injected. This was carried out for a series of gating pulse durations (i.e. varying the duration of time period 1330). The results are plotted in FIG. 14, where the fraction of transmitted ions is plotted against the fraction of time that the gating electrode is in the passing mode (compared to the total simulation time, which in this case is 0.5 ms). The dashed line is for reference only, and indicates the line that would be achieved if the fraction of ions transmitted was directly proportional to the fraction of time for which the gating electrode was in the passing mode. The solid line is fitted to the results of the simulation, and has a similar gradient to the dashed line but is horizontally offset. This is due to the finite reaction time of ions moving through the gating region. The offset time scales approximately as \sqrt{m/z}. Where the gating electrode is in the passing mode for a very short time period, the transmission may be very low. This may be compensated for, for example as described in US 7638763 B2.

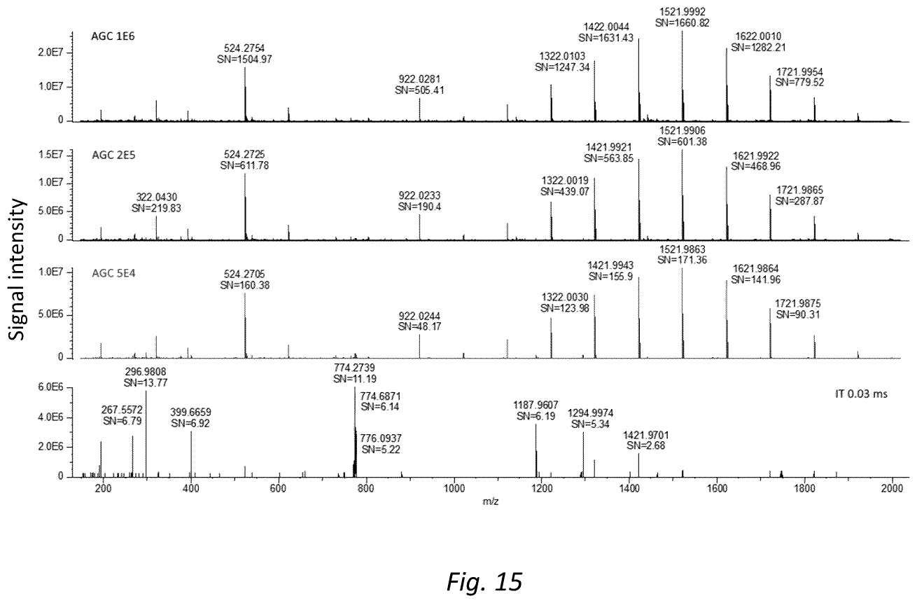

Ion spectra were acquired for ions passing through an ion guide according to an embodiment of the present disclosure. Spectra acquired from FlexMix calibrant solution are shown in FIG. 15. For the top three spectra, the ion guide was configured to allow a certain number of charges to be transmitted, which were injected into an Orbitrap and analysed. For the top spectrum the number of charges is 1E6, for the second spectrum the number of charges is 2E5, and for the third spectrum the number of charges is 5E4. No significant distortion to the spectra is visible. For the bottom spectrum, the ion guide was configured to be in the passing mode for 0.03 ms (approximately two orders of magnitude lower than for the top spectrum). The ions were blocked, and only electronic noise peaks remain.

As described above, the gating electrodes may have cylindrical symmetry. Given the linear profile along an axis of a cylindrical gating electrode, the gating electrode may be configured to be removable from the ion guide, for example to remove contamination. A cylindrical gating electrode may be configured to be rotatable around its axis, for example in order to move a contaminated section away from the ion guide axis. In other embodiments, the gating electrodes may have other cross-sectional shapes. For example, a cross-section of a gating electrode may be elliptical, square, rectangular or C-shaped. The cross-section of the gating electrode may be designed to optimize the electric field in the vicinity of the electrodes, or to enlarge the surface area exposed to deflected ions. A larger surface area exposed to deflected ions can help to increase the time before cleaning becomes necessary. A larger surface may be achieved by using a threaded or otherwise structured surface.

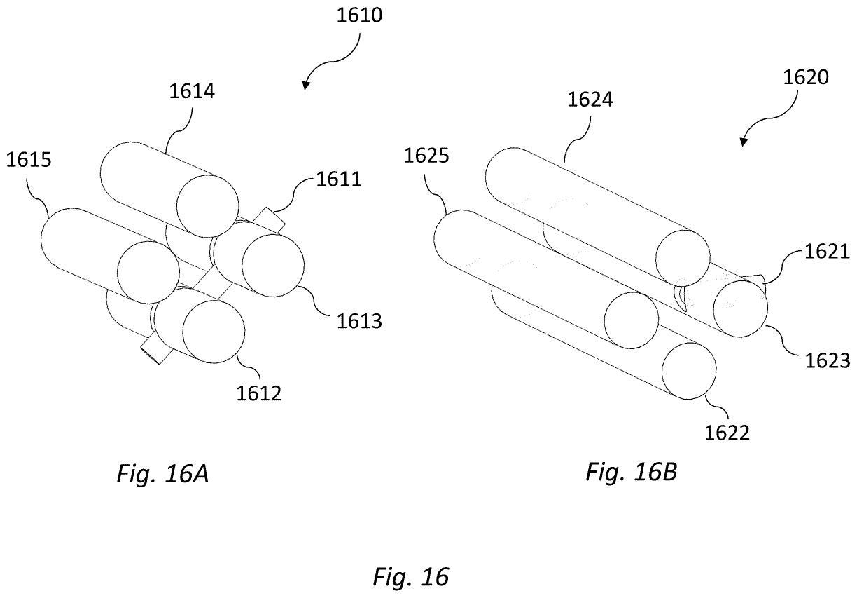

The gating electrodes shown above are oriented vertically. However, they may have different orientations. With reference to FIG. 16, an ion gate is illustrated with quadrupole guide electrodes similar to those in FIG. 1. The ion gate 1610 illustrated in FIG. 16A comprises a gating electrode 1611 having an angle of 45° to the vertical. The gating electrode 1611 may intersect with two guide electrodes 1612 and 1613 of the quadrupole guide electrodes 1612, 1613, 1614 and 1615. Slots in the two guide electrodes 1612 and 1613 allow the field to penetrate from the gating electrode towards the centre axis of the ion gate 1610. The ion gate 1610 may comprise a second gating electrode intersecting the other two guide electrodes 1614 and 1615. The ion gate 1620 illustrated in FIG. 16B comprises a gating electrode 1621 that is oriented horizontally and intersects guide electrode 1623. Guide electrode 1623 comprises a circular aperture to allow the field from the gating electrode to penetrate the ion gate 1620. The ion gate 1620 further comprises guide electrodes 1622, 1624, and 1625. The ion gate 1620 may comprise a second gating electrode. The one or more gating electrode(s) of ion gate 1520 may more generally be oriented in any radial direction. The gating electrode 1611 intersects the guide electrodes 1612 and 1613 such that the guide electrodes 1612 and 1613 are each continuous about the gating electrode 1611. The gating electrode 1611 is outside of a central volume that is centred about the central axis and has a radius that is defined by the smallest distance from the central axis to a surface of the guide electrodes.

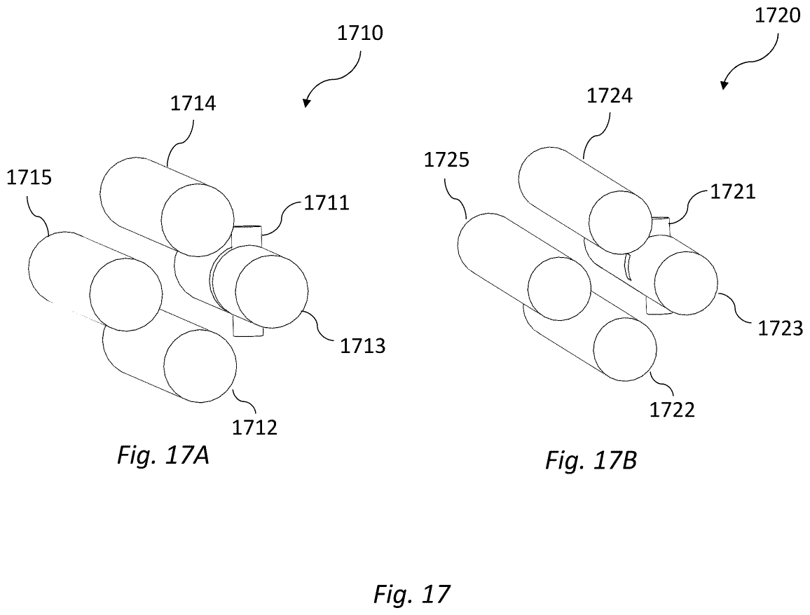

FIG. 17A illustrates an ion gate 1710 similar to ion gate 100 of FIG. 1, comprising guide electrodes 1712, 1713, 1714 and 1715 but comprising a single gating electrode 1711. As for FIG. 1, the gating electrode 1711 intersects a guide electrode 1713, wherein the guide electrode 1713 comprises a slot to allow the field from the gating electrode to penetrate the ion gate 1710. FIG. 17B illustrates an ion gate 1720 similar to ion gate 1710 of FIG. 17A, comprising guide electrodes 1722, 1723, 1724 and 1725 and comprising a single gating electrode 1721. As for FIG. 17A, the gating electrode 1721 intersects a guide electrode 1723. However, the guide electrode 1723 comprises an aperture to allow the field from the gating electrode to penetrate the ion gate 1720. The guide electrode 1713 is continuous about the gating electrode 1711 (on a side of the guide electrode 1713 furthest from the central axis) in a direction parallel to the central axis.

The guide electrodes discussed above have a quadrupole configuration. The guide electrodes may be a multipole of higher order.

In certain embodiments, each of the plurality of guide electrodes may be symmetrical along a linear axis. In certain embodiments, each of the plurality of guide electrodes may comprise a rod electrode. In certain embodiments, each of the plurality of guide electrodes may have cylindrical symmetry. In certain embodiments, each of the plurality of guide electrodes may have a rectangular cross-section.

As discussed, with the gating electrodes in the gating mode the ion beam may be deflected laterally away from the central axis of the ion guide and towards a gating electrode with an attractive potential. In certain embodiments, the gating electrodes in the gating mode may have any combination of attractive, repulsive or neutral potential with respect to the ion guide DC potential. For example, one gating electrode may have an attractive potential and one gating electrode may have a repulsive potential. In certain embodiments, instead of deflecting the ion beam laterally in the gating mode, such that the ions are not stored in the ion guide, the ion beam may be stored within the ion guide by applying a repulsive potential to all gating electrodes.

An ion guide or ion gate of any of the embodiments discussed herein may be integrated into an RF-ion guide such that the RF-ion guide is continuous upstream and downstream of the gating electrodes. According to certain embodiments of the disclosure, an ion guide is provided wherein the ion guide comprises an ion gate according to any of the embodiments described herein.

According to certain embodiments of the disclosure, a mass spectrometer comprises an ion guide, wherein the ion guide comprises a first ion gate according to any of the embodiments described herein.

The mass spectrometer may further comprise a second ion gate. The second ion gate may comprise an ion gate according to an embodiment of the present disclosure, or another type of ion gate. For example, the second ion gate may comprise a split lens or an ion funnel. In certain embodiments, the second ion gate may be positioned upstream of the first ion gate, wherein the ion guide is configured to receive an ion beam such that an ion beam reaches the second ion gate before the first ion gate. The response time of the second ion gate may be slower than the response time of the first ion gate. For example, the second ion gate may comprise an ion funnel configured to receive pulsed voltages. In certain embodiments, the first ion gate may be positioned upstream of the second ion gate, wherein the ion guide is configured to receive an ion beam such that an ion beam reaches the first ion gate before the second ion gate. The response time of the first ion gate may be slower than the response time of the second ion gate. For example, the second ion gate may comprise a split lens. A response time of an ion gate may be the time taken for the ion gate to be changed from the passing mode to the gating mode, or from the gating mode to the passing mode. For example, in an event that the ion gate is being changed from the passing mode to the gating mode, the response time may be the time taken for the transmission of ions through the ion gate to be stopped after the instruction to change to the gating mode.

A method of controlling transmission of an ion beam through an ion gate in a mass spectrometer is provided, wherein the ion gate comprises any ion gate described herein. The ion gate comprises a first electrode assembly comprising a plurality of guide electrodes aligned along a central axis. The plurality of guide electrodes are arranged to define a multipole ion guide from a first end of the first electrode assembly to a second end of the first electrode assembly. The ion guide is configured to receive an ion beam at the first end. The ion gate further comprises a second electrode assembly comprising at least one gating electrode positioned adjacent to the first electrode assembly; outside of the confinement volume; and at a first axial distance from the first end of the electrode assembly and at a second axial distance from the second end of the first electrode assembly. The method comprises applying RF voltages to the plurality of guide electrodes to define a confinement volume for the ion beam, wherein the confinement volume is centred about the central axis. The method further comprises allowing transmission of the ion beam by applying a passing DC voltage to the at least one gating electrode such that the ion beam is transmitted along the ion guide. The method further comprises preventing transmission of the ion beam by applying a gating DC voltage to the at least one gating electrode such that the ion beam is prevented from transmission along the ion guide.

In certain embodiments, applying the gating DC voltage to the gating electrode may attract the ion beam such that the ion beam is deflected towards a gating electrode.

In certain embodiments, the second electrode assembly comprises a first gating electrode and a second gating electrode. In a passing mode, the passing DC voltage with respect to an ion guide DC offset is applied to the first and second gating electrodes. In a gating mode, the gating DC voltage is applied to the first gating electrode and the passing DC voltage is applied to the second gating electrode. In a passing mode, the passing DC voltage with respect to an ion guide DC offset may be applied to the first gating electrode and to the second gating electrode with the same polarity. In a gating mode, the gating DC voltage may be applied to the first gating electrode with a first polarity and the gating DC voltage may be applied to the second gating electrode with a second polarity opposite to the first polarity.

1. An ion gate for a mass spectrometer, the ion gate comprising:
a first electrode assembly comprising a plurality of guide electrodes aligned along a central axis, wherein:
the plurality of guide electrodes are arranged to define a multipole ion guide from a first end of the first electrode assembly to a second end of the first electrode assembly, wherein at least one guide electrode is continuous from the first end of the first electrode assembly to the second end of the first electrode assembly;
the ion guide is configured to receive an ion beam at the first end; and
the plurality of guide electrodes are configured to receive RF voltages to define a confinement volume for the ion beam, wherein the confinement volume is centered about the central axis; and
a second electrode assembly comprising at least one gating electrode that intersects a guide electrode, wherein the at least one gating electrode is positioned:
adjacent to the first electrode assembly;
outside of the confinement volume; and
between the first end of the first electrode assembly and the second end of the first electrode assembly;
wherein the at least one gating electrode is configured to receive a DC voltage that is changeable between:
a passing DC voltage such that the ion beam is transmitted along the ion guide; and
a gating DC voltage such that the ion beam is prevented from transmission along the ion guide.

2. The ion gate of claim 1, wherein the at least one gating electrode intersects the guide electrode such that the guide electrode is continuous.

3. The ion gate of claim 1, wherein more than one guide electrode is continuous from the first end of the first electrode assembly to the second end of the first electrode assembly.

4. The ion gate of claim 1, wherein a radial distance of the at least one gating electrode from the central axis is no less than half a radial distance of the first electrode assembly from the central axis.

5. The ion gate of claim 1, wherein the at least one gating electrode is positioned outside of a central volume, wherein the central volume extends from the central axis to a surface of each of the plurality of guide electrodes that is closest to the central axis.

6. The ion gate of claim 1, wherein the at least one gating electrode is positioned at a first axial distance from the first end of the first electrode assembly and at a second axial distance from the second end of the first electrode assembly.

7. The ion gate of claim 1, wherein the first guide electrode is shaped such the first guide electrode does not fully shield the electric field of the gating electrode.

8. The ion gate of claim 1, wherein the first guide electrode comprises a slot configured to accommodate the gating electrode.

9. (canceled)

10. (canceled)

11. (canceled)

12. (canceled)

13. The ion gate of claim 1 wherein the plurality of ion guide electrodes comprises:
a first guide electrode and a second guide electrode, wherein the first guide electrode opposes the second guide electrode; and
a primary guide electrode assembly and a secondary guide electrode assembly, wherein the primary guide electrode assembly opposes the secondary guide electrode assembly;
wherein the primary guide electrode assembly comprises a first sheet electrode and a second sheet electrode, and the secondary guide electrode assembly comprises a third sheet electrode and a fourth sheet electrode;
wherein the gating electrode intersects the first sheet electrode and the second sheet electrode.

14. (canceled)

15. The ion gate of claim 1, further comprising one or more additional DC bias electrodes configured to provide an axial DC field, wherein the one or more DC bias electrodes are adjacent to the first electrode assembly and wherein the gating electrode intersects the one or more DC bias electrodes.

16. (canceled)

17. (canceled)

18. The ion gate of claim, 1 wherein the gating electrode is symmetrical along a linear axis.

19. (canceled)

20. (canceled)

21. (canceled)

22. The ion gate of claim 1, wherein when the gating electrode receives a gating DC voltage, the ion beam is deflected laterally away from the central axis and out of the confinement volume; or
wherein when the gating electrode receives a gating DC voltage, the ion beam is stored within the confinement volume.

23. (canceled)

24. An ion guide comprising the ion gate of claim 1.

25. A mass spectrometer comprising an ion guide, wherein the ion guide comprises a first ion gate according to claims 1.

26. The mass spectrometer of claim 25 further comprising a second ion gate;
wherein the second ion gate is positioned upstream of the first ion gate such that an ion beam reaches the second ion gate before the first ion gate and wherein a response time of the second ion gate is slower than a response time of the first ion gate, or
wherein the second ion gate is positioned downstream of the first ion gate such that an ion beam reaches the second ion gate after the first ion gate and wherein a response time of the second ion gate is faster than a response time of the first ion gate.

27. (canceled)

28. (canceled)

29. A method of controlling transmission of an ion beam through an ion gate in a mass spectrometer, wherein the ion gate comprises:
a first electrode assembly comprising a plurality of guide electrodes aligned along a central axis, wherein:
the plurality of guide electrodes are arranged to define a multipole ion guide from a first end of the first electrode assembly to a second end of the first electrode assembly, wherein at least one guide electrode is continuous from the first end of the first electrode assembly to the second end of the first electrode assembly; and
the ion guide is configured to receive an ion beam at the first end; and
a second electrode assembly comprising at least one gating electrode that intersects a guide electrode, wherein the at least one gating electrode is positioned:
adjacent to the first electrode assembly;
outside of the confinement volume; and
between the first end of the electrode assembly and the second end of the first electrode assembly;
the method comprising:
applying RF voltages to the plurality of guide electrodes to define a confinement volume for the ion beam, wherein the confinement volume is centered about the central axis;
allowing transmission of the ion beam by applying a passing DC voltage to the at least one gating electrode such that the ion beam is transmitted along the ion guide; and
preventing transmission of the ion beam by applying a gating DC voltage to the at least one gating electrode such that the ion beam is prevented from transmission along the ion guide.

30. The method of claim 29 wherein applying the gating DC voltage to the gating electrode attracts the ion beam such that the ion beam is deflected towards a gating electrode.

31. The method of claim 29, wherein the second electrode assembly comprises a first gating electrode and a second gating electrode and wherein:
in a passing mode the passing DC voltage with respect to an ion guide DC offset is applied to the first and second gating electrodes; and
in a gating mode the gating DC voltage is applied to the first gating electrode and the passing DC voltage is applied to the second gating electrode.

32. The method of claim 29, wherein the second electrode assembly comprises a first gating electrode and a second gating electrode and wherein:
in a passing mode the passing DC voltage with respect to an ion guide DC offset is applied to the first gating electrode and to the second gating electrode with the same polarity; and
in a gating mode the gating DC voltage is applied to the first gating electrode with a first polarity and the gating DC voltage is applied to the second gating electrode with a second polarity opposite to the first polarity.

33. The ion gate of claim 1, wherein all of the guide electrodes are continuous from the first end of the first electrode assembly to the second end of the first electrode assembly.
